(19) United States
(12) Patent Application Publication
(10) Pub. No.: US 2025/0286947 A1
(43) Pub. Date: Sep. 11, 2025

(54) APP-Based Event Type Detection

(71) Applicant: Vivint LLC, Provo, UT (US)

(72) Inventors: Morgan Wheaton, Provo, UT (US); Ethan Lawrence, Provo, TX (US); Nathan Wall, Provo, TX (US)

(73) Assignee: Vivint LLC, Provo, UT (US)

(21) Appl. No.: 19/061,423

(22) Filed: Feb. 24, 2025

Related U.S. Application Data
(60) Provisional application No. 63/561,979, filed on Mar. 6, 2024.

(51) Int. Cl. H04M 1/72418; G06F 3/01; G06F 3/0484

(52) U.S. Cl. CPC H04M 1/72418; G06F 3/017; G06F 3/0484

(57) ABSTRACT

Systems and methods for app-based event type detection are disclosed. One method for reporting an event may include displaying, on a user interface, one or more user-interactive feature(s) that are selectable by a user. In response to the user selecting one of the first user-interactive features, the method may further include displaying a plurality of second user-interactive features that are selectable by the user using a predetermined gesture. In response to the user selecting one of the second user-interactive features by performing the predetermined gesture, the method may include generating a message including an identifier indicative of the selected second user-interactive feature. The method may further include communicating, by the electronic device, the message including the identifier indicative of the selected second user-interactive feature to an event center.

### CROSS REFERENCE

This application claims priority to U.S. Provisional Patent Application, 63/561,979, filed Mar. 6, 2024, and entitled APP-BASED EVENT TYPE DETECTION, which is incorporated by reference herein in its entirety.

### TECHNICAL FIELD

The current disclosure generally relates to smart home security systems and added details of events when using an app.

### BACKGROUND

Emergency events come in various forms. Sometimes an emergency event may be a home intruder, while other times the emergency event may be a fire. Still yet, other emergency events may be in the form of a health emergency. Home security systems and apps, such as mobile apps, that may be used to communicate the emergency event to a monitoring service or event center such that an event center operator may perform an emergency dispatch to the proper authority (e.g., fire, police, ambulance, etc.). While an event center operator may be informed that an emergency has occurred in response to a user reporting an emergency when using an app of the security system, event center operators does not know the type of emergency such that the operator must call the user to determine the type of emergency. And, in the event of a home intruder or fire, for example, it is not always possible for the user to answer the phone, which means that the event center operator generally notifies police to visit the location of the emergency to further assess the situation. A delay to get proper emergency responder(s) (e.g., firemen) to the location may result in injury or death.

### SUMMARY

The current disclosure relates to systems and methods for app-based event type detection. The principles described herein enable a monitoring service (or event center), after receiving a signal indicating an emergency from a user of a smart lock system, to determine the type of emergency (e.g., emergency event category and device identifier) that led to the user communicating the signal to the event center as a result of additional emergency information being available to a user to submit via an app.

One method for reporting an event may include displaying, on a user interface being executed by an electronic device, one or more user-interactive feature(s) that are selectable by a user. In response to the user selecting one of the first user-interactive features, the method may further include displaying a plurality of second user-interactive features that are selectable by the user using a predetermined gesture. Further, in response to the user selecting one of the second user-interactive features by performing the predetermined gesture, the method may include generating a message including an identifier indicative of the selected second user-interactive feature. The method may further include communicating, by the electronic device, the message including the identifier indicative of the selected second user-interactive feature to an event center.

Another embodiment relates to a system including a non-transitory memory, an electronic display, and an input/output (I/O) unit. The system may include one or more processor(s) in communication with the memory, electronic display, and I/O unit and the processor(s) may be configured to display, on the electronic display, a user interface including at least one first user-interactive feature that is selectable by a user. In response to the user selecting one of the first user-interactive features, the processor(s) may be further configured to display, on the electronic display, a plurality of second user-interactive features that are selectable by the user using a predetermined gesture. In response to the user selecting one of the second user-interactive features by performing the predetermined gesture, the processor(s) may be further configured to generate a message including an identifier indicative of the selected second user-interactive feature. Further, the processor(s) may be configured to communicate the message including the identifier indicative of the selected second user-interactive feature to an event center . . .

### BRIEF DESCRIPTION OF THE FIGURES

A more complete understanding of the method and apparatus of the present invention may be obtained by reference to the following Detailed Description when taken in conjunction with the accompanying figures wherein:

FIG. 1 is a perspective view illustrating one embodiment of a security system of a residence, according to an embodiment;

FIG. 2 is a block diagram of a system including a network environment inclusive of a home security system (e.g., hub) at a residence, monitoring service in communication with the home security system of the residence, and emergency services with which the monitoring service may communicate in the event of an emergency event reported to the monitoring service, according to an embodiment;

FIG. 3 is an illustration of an illustrative controller configured to operate a hub or other electronic device configured to support an app for reporting emergency events, according to an embodiment;

FIG. 4 is an illustration of a an electronic device executing software configured to generate illustrative user interface(s) used in app-based event detection, according to an embodiment;

FIG. 5 is a “swim-lane” flowchart of an illustrative process for app-based event detection, according to an embodiment; and

FIG. 6 is a flowchart of an illustrative process for app-based event detection, according to an embodiment.

### DETAILED DESCRIPTION

Before turning to the figures, which illustrate certain illustrative embodiments in detail, it should be understood that the present disclosure is not limited to the details or methodology set forth in the description or illustrated in the figures. It should also be understood that the terminology used herein is for the purpose of description only and should not be regarded as limiting.

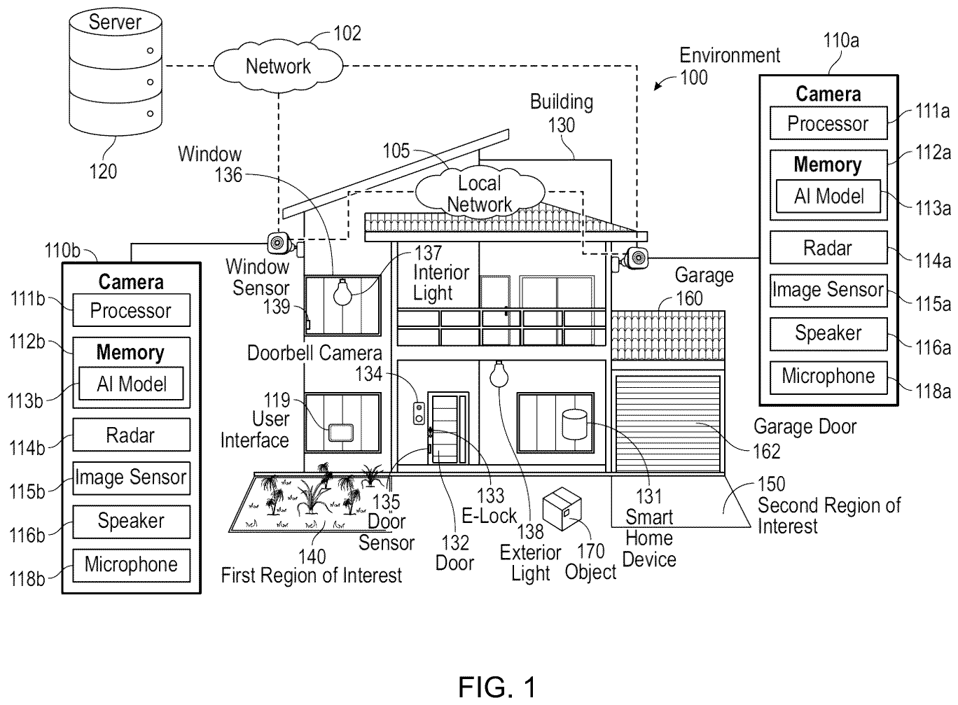

FIG. 1 illustrates an example environment 100, such as a residential property, in which the present systems and methods may be implemented. The environment 100 may include a site that can include one or more structures, any of which can be a structure or building 130, such as a home, office, warehouse, garage, and/or the like. The building 130 may include various entryways, such as one or more doors 132, one or more windows 136, and/or a garage 160 having a garage door 162. The environment 100 may include multiple sites. In some implementations, the environment 100 includes multiple sites, each corresponding to a different property and/or building. In an example, the environment 100 may be a cul-de-sac that includes multiple buildings 130.

The building 130 may include a security system 101 or one or more security devices that are configured to detect and mitigate crime and property theft and damage by alerting a trespasser or intruder that their presence is known while optionally alerting a monitoring service about detecting a trespasser or intruder (e.g., burglar). The security system 101 may include a variety of hardware components and software modules or programs configured to monitor and protect the environment 100 and one or more buildings 130 located thereat. In an embodiment, the security system 101 may include one or more sensors (e.g., cameras, microphones, vibration sensors, pressure sensors, motion detectors, proximity sensors (e.g., door or window sensors), range sensors, etc.), lights, speakers, and optionally one or more controllers (e.g., hub) at the building 130 in which the security system 101 is installed. In an embodiment, the cameras, sensors, lights, speakers, and/or other devices may be smart by including one or more processors therewith to be able to process sensed information (e.g., images, sounds, motion, etc.) so that decisions may be made by the processor(s) as to whether the captured information is associated with a security risk or otherwise.

The sensor(s) of the security system 101 may be used to detect a presence of a trespasser or intruder of the environment (e.g., outside, inside, above, or below the environment) such that the sensor(s) may automatically send a communication to the controller(s). The communication may occur whether or not the security system 101 is armed, but if armed, the controller(s) may initiate a different action than if not armed. For example, if the security system 101 is not armed when an entity is detected, then the controller(s) may simply record that a detection of an entity occurred without sending a communication to a monitoring service or taking local action (e.g., outputting an alert or other alarm audio signal) and optionally notify a user via a mobile app or other communication method of the detection of the entity. If the security system 101 is armed when a detection of an entity is made, then the controller(s) may initiate a disarm countdown timer (e.g., 60 seconds) to enable a user to disarm the security system 101 via a controller, mobile app, or otherwise, and, in response to the security system 101 not being disarmed (or being accepted by a user prior to completion of the countdown timer), communicate a notification including detection information (e.g., image, sensor type, sensor location, etc.) to a monitoring service (optionally after giving a user a chance to disarm the security system 101), which may, in turn, notify public authorities, such as police, to dispatch a unit to the environment 100, initiate an alarm (e.g., output an audible signal) local to the environment 100, communicate a message to a user via a mobile app or other communication (e.g., text message), or otherwise.

In the event that the security system 101 is armed and detects a trespasser or intruder, then the security system 101 may be configured to generate and communicate a message to a monitoring service of the security system 101. The monitoring service may be a third-party monitoring service (i.e., a service that is not the provider of the security system 101). The message may include a number of parameters, such as location of the environment 100, type of sensor, location of the sensor, image(s) if received, and any other information received with the message. It should be understood that the message may utilize any communications protocol for communicating information from the security service to the monitoring service. The message and data contained therein may be used to populate a template on a user interface of the monitoring service such that an operator at the monitoring service may view the data to assess a situation. In an embodiment, a user of the security system 101 may be able to provide additional information that may also be populated on the user interface for an operator in determining whether to contact the authorities to initiate a dispatch. The monitoring service may utilize a standard procedure in response to receiving the message in communicating with a user of the security service and/or dispatching the authorities.

A first camera 110a and a second camera 110b, referred to herein collectively as cameras 110, may be disposed at the environment 100, such as outside and/or inside the building 130. The cameras 110 may be attached to the building 130, such as at a front door of the building 130 or inside of a living room. The cameras 110 may communicate with each other over a local network 105. The cameras 110 may communicate with a server 120 over a network 102. The local network 105 and/or the network 102, in some implementations, may each include a digital communication network that transmits digital communications. The local network 105 and/or the network 102 may each include a wireless network, such as a wireless cellular network, a local wireless network, such as a Wi-Fi network, a Bluetooth® network, a near-field communication (“NFC”) network, an ad hoc network, and/or the like. The local network 105 and/or the network 102 may each include a wide area network (“WAN”), a storage area network (“SAN”), a local area network (“LAN”) (e.g., a home network), an optical fiber network, the internet, or other digital communication network. The local network 105 and/or the network 102 may each include two or more networks. The network 102 may include one or more servers, routers, switches, and/or other networking equipment. The local network 105 and/or the network 102 may also include one or more computer readable storage media, such as a hard disk drive, an optical drive, non-volatile memory, RAM, or the like.

The local network 105 and/or the network 102 may be a mobile telephone network. The local network 105 and/or the network 102 may employ a Wi-Fi network based on any one of the Institute of Electrical and Electronics Engineers (“IEEE”) 802.11 standards. The local network 105 and/or the network 102 may employ Bluetooth® connectivity and may include one or more Bluetooth connections. The local network 105 and/or the network 102 may employ Radio Frequency Identification (“RFID”) communications, including RFID standards established by the International Organization for Standardization (“ISO”), the International Electrotechnical Commission (“IEC”), the American Society for Testing and Materials® (ASTM®), the DASH7™ Alliance, and/or EPCGlobal™

In some implementations, the local network 105 and/or the network 102 may employ ZigBee® connectivity based on the IEEE 802 standard and may include one or more ZigBee connections. The local network 105 and/or the network 102 may include a ZigBee® bridge. In some implementations, the local network 105 and/or the network 102 employs Z-Wave® connectivity as designed by Sigma Designs® and may include one or more Z-Wave connections. The local network 105 and/or the network 102 may employ an ANT® and/or ANT+® connectivity as defined by Dynastream® Innovations Inc. of Cochrane, Canada and may include one or more ANT connections and/or ANT+connections.

The first camera 110a may include an image sensor 115a, a processor 111a, a memory 112a, a radar sensor 114a, a speaker 116a, and a microphone 118a. The memory 112a may include computer-readable, non-transitory instructions which, when executed by the processor 111a, cause the processor 111a to perform methods and operations discussed herein. The processor 111a may include one or more processors. The second camera 110b may include an image sensor 115b, a processor 111b, a memory 112b, a radar sensor 114b, a speaker 116b, and a microphone 118b. The memory 112b may include computer-readable, non-transitory instructions which, when executed by the processor 111b, cause the processor to perform methods and operations discussed herein. The processor 111a may include one or more processors.

The memory 112a may include an AI model 113a. The AI model 113a may be applied to or otherwise process data from the camera 110a, the radar sensor 114a, and/or the microphone 118a to detect and/or identify one or more objects (e.g., people, animals, vehicles, shipping packages or other deliveries, or the like), one or more events (e.g., arrivals, departures, weather conditions, crimes, property damage, or the like), and/or other conditions. For example, the cameras 110 may determine a likelihood that an object 170, such as a package, vehicle, person, or animal, is within an area (e.g., a geographic area, a property, a room, a field of view of the first camera 110a, a field of view of the second camera 110b, a field of view of another sensor, or the like) based on data from the first camera 110a, the second camera 110b, and/or other sensors.

The memory 112b of the second camera 110b may include an AI model 113b. The AI model 113b may be similar to the AI model 113a. In some implementations, the AI model 113a and the AI model 113b have the same parameters. In some implementations, the AI model 113a and the AI model 113b are trained together using data from the cameras 110. In some implementations, the AI model 113a and the AI model 113b are initially the same, but are independently trained by the first camera 110a and the second camera 110b, respectively. For example, the first camera 110a may be focused on a porch and the second camera 110b may be focused on a driveway, causing data collected by the first camera 110a and the second camera 110b to be different, leading to different training inputs for the first AI model 113a and the second AI model 113b. In some implementations, the AI models 113 are trained using data from the server 120. In an example, the AI models 113 are trained using data collected from a plurality of cameras associated with a plurality of buildings. The cameras 110 may share data with the server 120 for training the AI models 113 and/or a plurality of other AI models. The AI models 113 may be trained using both data from the server 120 and data from their respective cameras.

The cameras 110, in some implementations, may determine a likelihood that the object 170 (e.g., a package) is within an area (e.g., a portion of a site or of the environment 100) based at least in part on audio data from microphones 118, using sound analytics and/or the AI models 113. In some implementations, the cameras 110 may determine a likelihood that the object 170 is within an area based at least in part on image data using image processing, image detection, and/or the AI models 113. The cameras 110 may determine a likelihood that an object is within an area based at least in part on depth data from the radar sensors 114, a direct or indirect time of flight sensor, an infrared sensor, a structured light sensor, or other sensor. For example, the cameras 110 may determine a location for an object, a speed of an object, a proximity of an object to another object and/or location, an interaction of an object (e.g., touching and/or approaching another object or location, touching a car/automobile or other vehicle, touching or opening a mailbox, leaving a package, leaving a car door open, leaving a car running, touching a package, picking up a package, or the like), and/or another determination based at least in part on depth data from the radar sensors 114.

The sensors, such as cameras 110, radar sensors 114, microphones 118, door sensors, window sensors, or other sensors, may be configured to detect a breach of security event for which the respective sensors are configured. For example, the microphones 118 may be configured to sense sounds, such as voices, broken glass, door knocking, or otherwise, and an audio processing system may be configured to process the audio so as to determine whether the captured audio signals are indicative of a trespasser or potential intruder of the environment 100 or building 130. Each of the signals generated or captured by the different sensors may be processed so as to determine whether the sounds are indicative of a security risk or not, and the determination may be time and/or situation dependent. For example, responses to sounds made when the security system 101 is armed may be different to responses to sounds when the security system 101 is unarmed.

A user interface 119 may be installed or otherwise located at the building 130. The user interface 119 may be part of or executed by a device, such as a mobile phone, a tablet, a laptop, wall panel, or other device. The user interface 119 may connect to the cameras 110 via the network 102 or the local network 105. The user interface 119 may allow a user to access sensor data of the cameras 110. In an example, the user interface 119 may allow the user to view a field of view of the image sensors 115 and hear audio data from the microphones 118. In an example, the user interface may allow the user to view a representation, such as a point cloud, of radar data from the radar sensors 114.

The user interface 119 may allow a user to provide input to the cameras 110. In an example, the user interface 119 may allow a user to speak or otherwise provide sounds using the speakers 116.

In some implementations, the cameras 110 may receive additional data from one or more additional sensors, such as a door sensor 135 of the door 132, an electronic lock 133 of the door 132, a doorbell camera 134, and/or a window sensor 139 of the window 136. The door sensor 135, the electronic lock 133, the doorbell camera 134 and/or the window sensor 139 may be connected to the local network 105 and/or the network 102. The cameras 110 may receive the additional data from the door sensor 135, the electronic lock 133, the doorbell camera 134 and/or the window sensor 139 from the server 120.

In some implementations, the cameras 110 may determine separate and/or independent likelihoods that an object is within an area based on data from different sensors (e.g., processing data separately, using separate machine learning and/or other artificial intelligence, using separate metrics, or the like). The cameras 110 may combine data, likelihoods, determinations, or the like from multiple sensors such as image sensors 115, the radar sensors 114, and/or the microphones 118 into a single determination of whether an object is within an area (e.g., in order to perform an action relative to the object 170 within the area. For example, the cameras 110 and/or each of the cameras 110 may use a voting algorithm and determine that the object 170 is present within an area in response to a majority of sensors of the cameras and/or of each of the cameras determining that the object 170 is present within the area. In some implementations, the cameras 110 may determine that the object 170 is present within an area in response to all sensors determining that the object 170 is present within the area (e.g., a more conservative and/or less aggressive determination than a voting algorithm). In some implementations, the cameras 110 may determine that the object 170 is present within an area in response to at least one sensor determining that the object 170 is present within the area (e.g., a less conservative and/or more aggressive determination than a voting algorithm).

The cameras 110, in some implementations, may combine confidence metrics indicating likelihoods that the object 170 is within an area from multiple sensors of the cameras 110 and/or additional sensors (e.g., averaging confidence metrics, selecting a median confidence metric, or the like) in order to determine whether the combination indicates a presence of the object 170 within the area. In some embodiments, the cameras 110 are configured to correlate and/or analyze data from multiple sensors together. For example, the cameras 110 may detect a person or other object in a specific area and/or field of view of the image sensors 115 and may confirm a presence of the person or other object using data from additional sensors of the cameras 110 such as the radar sensors 114 and/or the microphones 118, confirming a sound made by the person or other object, a distance and/or speed of the person or other object, or the like. The cameras 110, in some implementations, may detect the object 170 with one sensor and identify and/or confirm an identity of the object 170 using a different sensor. In an example, the cameras detect the object 170 using the image sensor 115a of the first camera 110a and verifies the object 170 using the radar sensor 114b of the second camera 110b. In this manner, in some implementations, the cameras 110 may detect and/or identify the object 170 more accurately using multiple sensors than may be possible using data from a single sensor.

The cameras 110, in some implementations, in response to determining that a combination of data and/or determinations from the multiple sensors indicates a presence of the object 170 within an area, may perform initiate, or otherwise coordinate one or more actions relative to the object 170 within the area. For example, the cameras 110 may perform an action including emitting one or more sounds from the speakers 116, turning on a light, turning off a light, directing a lighting element toward the object 170, opening or closing the garage door 162, turning a sprinkler on or off, turning a television or other smart device or appliance on or off, activating a smart vacuum cleaner, activating a smart lawnmower, and/or performing another action based on a detected object, based on a determined identity of a detected object, or the like. In an example, the cameras 110 may actuate an interior light 137 of the building 130 and/or an exterior light 138 of the building 130. The interior light 137 and/or the exterior light 138 may be connected to the local network 105 and/or the network 102.

In some embodiments, the security system 101 and/or security device may perform initiate, or otherwise coordinate an action selected to deter a detected person (e.g., to deter the person from the area and/or property, to deter the person from damaging property and/or committing a crime, or the like), to deter an animal, or the like. For example, based on a setting and/or mode, in response to failing to identify an identity of a person (e.g., an unknown person, an identity failing to match a profile of an occupant or known user in a library, based on facial recognition, based on bio-identification, or the like), and/or in response to determining a person is engaged in suspicious behavior and/or has performed a suspicious action, or the like, the cameras 110 may perform, initiate, or otherwise coordinate an action to deter the detected person. In some implementations, the cameras 110 may determine that a combination of data and/or determinations from multiple sensors indicates that the detected human is, has, intends to, and/or may otherwise perform one or more suspicious acts, from a set of predefined suspicious acts or the like, such as crawling on the ground, creeping, running away, picking up a package, touching an automobile and/or other vehicle, opening a door of an automobile and/or other vehicle, looking into a window of an automobile and/or other vehicle, opening a mailbox, opening a door, opening a window, throwing an object, or the like.

In some implementations, the cameras 110 may monitor one or more objects based on a combination of data and/or determinations from the multiple sensors. For example, in some embodiments, the cameras 110 may detect and/or determine that a detected human has picked up the object 170 (e.g., a package, a bicycle, a mobile phone or other electronic device, or the like) and is walking or otherwise moving away from the home or other building 130. In a further embodiment, the cameras 110 may monitor a vehicle, such as an automobile, a boat, a bicycle, a motorcycle, an offroad and/or utility vehicle, a recreational vehicle, or the like. The cameras 110, in various embodiments, may determine if a vehicle has been left running, if a door has been left open, when a vehicle arrives and/or leaves, or the like.

The environment 100 may include one or more regions of interest, which each may be a given area within the environment. A region of interest may include the entire environment 100, an entire site within the environment, or an area within the environment. A region of interest may be within a single site or multiple sites. A region of interest may be inside of another region of interest. In an example, a property-scale region of interest which encompasses an entire property within the environment 100 may include multiple additional regions of interest within the property.

The environment 100 may include a first region of interest 140 and/or a second region of interest 150. The first region of interest 140 and the second region of interest 150 may be determined by the AI models 113, fields of view of the image sensors 115 of the cameras 110, fields of view of the radar sensors 114, and/or user input received via the user interface 119. In an example, the first region of interest 140 includes a garden or other landscaping of the building 130 and the second region of interest 150 includes a driveway of the building 130. In some implementations, the first region of interest 140 may be determined by user input received via the user interface 119 indicating that the garden should be a region of interest and the AI models 113 determining where in the fields of view of the sensors of the cameras 110 the garden is located. In some implementations, the first region of interest 140 may be determined by user input selecting, within the fields of view of the sensors of the cameras 110 on the user interface 119, where the garden is located. Similarly, the second region of interest 150 may be determined by user input indicating, on the user interface 119, that the driveway should be a region of interest and the AI models 113 determining where in the fields of view of the sensors of the cameras 110 the driveway is located. In some implementations, the second region of interest 150 may be determined by user input selecting, on the user interface 119, within the fields of view of the sensors of the cameras 110, where the driveway is located.

In response to determining that a combination of data and/or determinations from the multiple sensors indicates that a detected human (e.g., an entity) is, has, intends to, and/or may otherwise perform one or more suspicious acts, is unknown/unrecognized, has entered a restricted area/zone such as the first region of interest 140 or the second region of interest 150, the security system 101 and/or security devices may expedite a deter action, reduce a waiting/monitoring period after detecting the human and before performing a deter action, or the like. In response to determining that a combination of data and/or determinations from the multiple sensors indicates that a detected human is continuing and/or persisting performance of one or more suspicious acts, the cameras 110 may escalate one or more deter actions, perform one or more additional deter actions (e.g., a more serious deter action), or the like. For example, the cameras 110 may play an escalated and/or more serious sound such as a siren, yelling, or the like; may turn on a spotlight, strobe light, or the like; and/or may perform, initiate, or otherwise coordinate another escalated and/or more serious action. In some embodiments, the cameras 110 may enter a different state (e.g., an armed mode, a security mode, an away mode, or the like) in response to detecting a human in a predefined restricted area/zone or other region of interest, or the like (e.g., passing through a gate and/or door, entering an area/zone previously identified by an authorized user as restricted, entering an area/zone not frequently entered such as a flowerbed, shed or other storage area, or the like).

In a further embodiment, the cameras 110 may perform, initiate, or otherwise coordinate, a welcoming action and/or another predefined action in response to recognizing a known human (e.g., an identity matching a profile of an occupant or known user in a library, based on facial recognition, based on bio-identification, or the like) such as executing a configurable scene for a user, activating lighting, playing music, opening or closing a window covering, turning a fan on or off, locking or unlocking a door 132, lighting a fireplace, powering an electrical outlet, turning on or play a predefined channel or video or music on a television or other device, starting or stopping a kitchen appliance, starting or stopping a sprinkler system, opening or closing a garage door 162, adjusting a temperature or other function of a thermostat or furnace or air conditioning unit, or the like. In response to detecting a presence of a known human, one or more safe behaviors and/or conditions, or the like, in some embodiments, the cameras 110 may extend, increase, pause, toll, and/or otherwise adjust a waiting/monitoring period after detecting a human, before performing a deter action, or the like.

In some implementations, the cameras 110 may receive a notification from a user's smart phone that the user is within a predefined proximity or distance from the home, e.g., on their way home from work. Accordingly, the cameras 110 may activate a predefined or learned comfort setting for the home, including setting a thermostat at a certain temperature, turning on certain lights inside the home, turning on certain lights on the exterior of the home, turning on the television, turning a water heater on, and/or the like.

The cameras 110, in some implementations, may be configured to detect one or more health events based on data from one or more sensors. For example, the cameras 110 may use data from the radar sensors 114 to determine a heartrate, a breathing pattern, or the like and/or to detect a sudden loss of a heartbeat, breathing, or other change in a life sign. The cameras 110 may detect that a human has fallen and/or that another accident has occurred.

In some embodiments, the security system 101 and/or one or more security devices may include one or more speakers 116. The speaker(s) 116 may be independent from other devices or integrated therein. For example, the camera(s) may include one or more speakers 116 (e.g. speakers 116a, 116b) that enable sound to be output therefrom. In an embodiment, a controller or other device may include a speaker from which sound (e.g., alarm sound, tones, verbal audio, and/or otherwise) may be output. The controller may be configured to cause audio sounds (e.g., verbal commands, dog barks, alarm sounds, etc.) to play and/or otherwise emit those audio from the speaker(s) 116 located at the building 130. In an embodiment, one or more sounds may be output in response to detecting the presence of a human within an area. For example, the controller may cause the speaker may play one or more sounds selected to deter a detected person from an area around a building 130, environment 100, and/or object. The speaker(s) 116, in some implementations, may vary sounds over time, dynamically layer and/or overlap sounds, and/or generate unique sounds, to preserve a deterrent effect of the sounds over time and/or to avoid, limit, or even prevent those being deterred from becoming accustomed to the same sounds used over and over.

The security system 101, one or more security devices, and/or the speakers 116, in some implementations, may be configured to store and/or has access to a library comprising a plurality of different sounds and/or a set of dynamically generated sounds so that the controller (e.g., user interface 119) may vary the different sounds over time, thereby not using the same sound too often. In some embodiments, varying and/or layering sounds allows a deter sound to be more realistic and/or less predictable.

One or more of the sounds may be selected to give a perception of human presence in the environment 100 or building 130, a perception of a human talking over an electronic speaker 116 in real-time, or the like which may be effective at preventing crime and/or property damage. For example, a library and/or other set of sounds may include audio recordings and/or dynamically generated sounds of one or more, male and/or female voices saying different phrases, such as for example, a female saying “hello?,” a female and male together saying “can we help you?,” a male with a gruff voice saying, “get off my property” and then a female saying “what's going on?,” a female with a country accent saying “hello there,” a dog barking, a teenager saying “don't you know you're on camera?,” and/or a man shouting “hey!” or “hey you!,” or the like.

In some implementations, the security system 101, one or more security devices, and/or the speaker 116 may dynamically generate one or more sounds (e.g., using machine learning and/or other artificial intelligence, or the like) with one or more attributes that vary from a previously played sound. For example, the security system, one or more security devices, and/or the speaker 116 may generate sounds with different verbal tones, verbal emotions, verbal emphases, verbal pitches, verbal cadences, verbal accents, or the like so that the sounds are said in different ways, even if they include some or all of the same words. In some embodiments, the security system 101, one or more security devices, the speaker 116 and/or a remote server 120 or other computing device, may train machine learning on reactions of previously detected humans in other areas to different sounds and/or sound combinations (e.g., improving sound selection and/or generation over time).

The security system 101, one or more security devices, and/or the speaker 116 may combine and/or layer these sounds (e.g., primary sounds), with one or more secondary, tertiary, and/or other background sounds, which may comprise background noises selected to give an appearance that a primary sound is a person speaking in real time, or the like. For example, a secondary, tertiary, and/or other background sound may include sounds of a kitchen, of tools being used, of someone working in a garage, of children playing, of a television being on, of music playing, of a dog barking, or the like. The security system 101, one or more security devices, and/or the speaker 116, in some embodiments, may be configured to combine and/or layer one or more tertiary sounds with primary and/or secondary sounds for more variety, or the like. For example, a first sound (e.g., a primary sound) may comprise a verbal language message and a second sound (e.g., a secondary and/or tertiary sound) may comprise a background noise for the verbal language message (e.g., selected to provide a real-time temporal impression for the verbal language message of the first sound, or the like).

In this manner, in various embodiments, the security system 101, one or more security devices, and/or the speaker 116 may intelligently track which sounds and/or combinations of sounds have been played, and in response to detecting the presence of a human, may select a first sound to play that is different than a previously played sound, may select a second sound to play that is different than the first sound, and may play the first and second sounds at least partially simultaneously and/or overlapping. For example, the security system 101, one or more security devices, and/or the speaker 116 may play a primary sound layered and/or overlapping with one or more secondary, tertiary, and/or background sounds, varying the sounds and/or the combination from one or more previously played sounds and/or combinations, or the like.

The security system 101, one or more security devices, and/or the speaker 116, in some embodiments, may select and/or customize an action based at least partially on one or more characteristics of a detected object. For example, the cameras 110 may determine one or more characteristics of the object 170 based on audio data, image data, depth data, and/or other data from a sensor. For example, the cameras 110 may determine a characteristic such as a type or color of an article of clothing being worn by a person, a physical characteristic of a person, an item being held by a person, or the like. The cameras 110 may customize an action based on a determined characteristic, such as by including a description of the characteristic in an emitted sound (e.g., “hey you in the blue coat!”, “you with the umbrella!”, or another description), or the like.

The security system 101, one or more security devices, and/or the speaker 116, in some implementations, may escalate and/or otherwise adjust an action over time and/or may perform a subsequent action in response to determining (e.g., based on data and/or determinations from one or more sensors, from the multiple sensors, or the like) that the object 170 (e.g., a human, an animal, vehicle, drone, etc.) remains in an area after performing a first action (e.g., after expiration of a timer, or the like). For example, the security system 101, one or more security devices, and/or the speaker 116 may increase a volume of a sound, emit a louder and/or more aggressive sound (e.g., a siren, a warning message, an angry or yelling voice, or the like), increase a brightness of a light, introduce a strobe pattern to a light, and/or otherwise escalate an action and/or subsequent action. In some implementations, the security system 101, one or more security devices, and/or the speaker 116 may perform a subsequent action (e.g., an escalated and/or adjusted action) relative to the object 170 in response to determining that movement of the object 170 satisfies a movement threshold based on subsequent depth data from the radar sensors 114 (e.g., subsequent depth data indicating the object 170 is moving and/or has moved at least a movement threshold amount closer to the radar sensors 114, closer to the building 130, closer to another identified and/or predefined object, or the like).

In some implementations, the cameras 110 and/or the server 120 (or other device), may include image processing capabilities and/or radar data processing capabilities for analyzing images, videos, and/or radar data that are captured with the cameras 110. The image/radar processing capabilities may include object detection, facial recognition, gait detection, and/or the like. For example, the controller 106 may analyze or process images and/or radar data to determine that a package is being delivered at the front door/porch. In other examples, the cameras 110 may analyze or process images and/or radar data to detect a child walking within a proximity of a pool, to detect a person within a proximity of a vehicle, to detect a mail delivery person, to detect animals, and/or the like. In some implementations, the cameras 110 may utilize the AI models 113 for processing and analyzing image and/or radar data.

In some implementations, the security system 101, one or more security devices, and/or the speaker 116 are connected to various loT devices. As used herein, an loT device may be a device that includes computing hardware to connect to a data network and to communicate with other devices to exchange information. In such an embodiment, the cameras 110 may be configured to connect to, control (e.g., send instructions or commands), and/or share information with different loT devices. Examples of loT devices may include home appliances (e.g. stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In some implementations, the cameras 110 may poll, request, receive, or the like information from the loT devices (e.g., status information, health information, power information, and/or the like) and present the information on a display and/or via a mobile application.

The loT devices may include a smart home device 131. The smart home device 131 may be connected to the loT devices. The smart home device 131 may receive information from the loT devices, configure the loT devices, and/or control the loT devices. In some implementations, the smart home device 131 provides the cameras 110 with a connection to the loT devices. In some implementations, the cameras 110 provide the smart home device 131 with a connection to the loT devices. The smart home device 131 may be an AMAZON ALEXA device, an AMAZON ECHO, A GOOGLE NEST device, a GOOGLE HOME device, or other smart home hub or device. In some implementations, the smart home device 131 may receive commands, such as voice commands, and relay the commands to the cameras 110. In some implementations, the cameras 110 may cause the smart home device 131 to emit sound and/or light, speak words, or otherwise notify a user of one or more conditions via the user interface 119.

In some implementations, the loT devices include various lighting components including the interior light 137, the exterior light 138, the smart home device 131, other smart light fixtures or bulbs, smart switches, and/or smart outlets. For example, the cameras 110 may be communicatively connected to the interior light 137 and/or the exterior light 138 to turn them on/off, change their settings (e.g., set timers, adjust brightness/dimmer settings, and/or adjust color settings).

In some implementations, the loT devices include one or more speakers within the building. The speakers may be stand-alone devices such as speakers that are part of a sound system, e.g., a home theatre system, a doorbell chime, a Bluetooth speaker, and/or the like. In some implementations, the one or more speakers may be integrated with other devices such as televisions, lighting components, camera devices (e.g., security cameras that are configured to generate an audible noise or alert), and/or the like. In some implementations, the speakers may be integrated in the smart home device 131.

### APP BASED-EVENT DETECTION

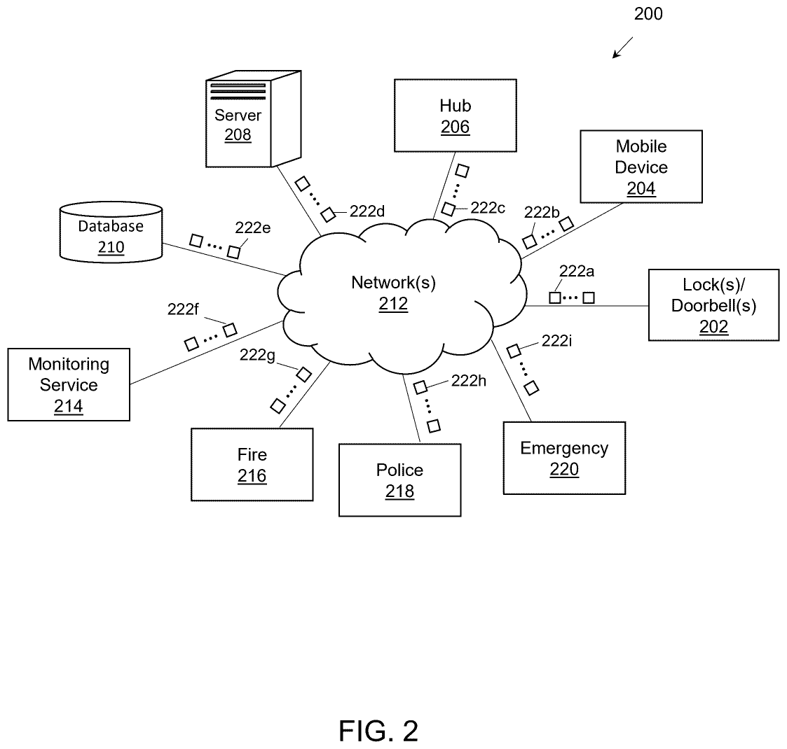

Turning now to FIG. 2, a network environment 200 inclusive of a home security system (e.g., hub) at a residence, monitoring service in communication with the home security system of the residence, and emergency services with which the monitoring service may communicate in the event of an emergency event reported to the monitoring, according to an embodiment. One or more elements of the network environment 200 may be located partially or entirely within the enclosed space (e.g., any building, edifice, or enclosure including one or more walls and one or more entrances). The network environment 200 may include one or more smart lock(s)/doorbell(s) 202. The network environment 200 may further include a mobile device 204 (e.g., a smartphone) of a user and a hub 206 located internal and/or external from the space. Further, the network environment 200 may include a server 208 (e.g., a cloud server), a database 210, and one or more networks 212 (e.g., a local network may be part of the network environment 200 provided by the security system). The network environment 200 may further include a monitoring service 214, a fire authority 216, a police authority 218, and an emergency authority 220. The various devices and components of the network environment 200 may communicate with one another via the one or more networks 212 and via the signals 222a-222i, as further described herein.

The lock(s)/doorbell(s) 202 may be any type of electronic device including hardware components (e.g., one or more processors, non-transitory memory, user interface, housing, etc.) and software components capable of performing the various processes and tasks described herein. Non-limiting examples of the lock(s)/doorbell(s) 202 may include smart home devices (e.g., smart locks, smart doorbells, “control panels”), personal computers (e.g., laptop computers, desktop computers), server computers, mobile devices (e.g., smartphones, tablets), VR devices, and gaming consoles, smart watches, among other types of electronic devices. The lock(s)/doorbell(s) 202 may include an electronic display, one or more indicators, a user input, a communication module, a lock engagement member, a physical housing, one or more sensors (e.g., cameras, proximity sensors, radar, sonar, infrared, etc.), and/or more, as further described herein. In some embodiments, the lock(s)/doorbell(s) 202 may include one or more primary exterior lock interface(s), primary interior lock interface(s), and/or secondary lock interface(s). Any of the lock(s)/doorbell(s) 202 may trigger an emergency event in the form of a potential intruder or other person to which an emergency alert to police may be appropriate.

In an embodiment, one or more of the lock(s)/doorbell(s) 202 may function for reporting and handling emergency events (e.g., a house fire, break-in, heart attack, etc.) to a central device (e.g., hub of alarm system) or a non-central device (e.g., mobile device) for use in reporting to a monitoring service. In an alternative embodiment, the lock(s)/doorbell(s) 202 may communicate with the monitoring service and be configured to optionally communicate in the event that the notification to the central device is not responded to, dismissed, or viewed within a certain time period. As described above, the lock(s)/doorbell(s) 202 may include an electronic display (e.g., LCD screen) configured to display information to a user.

The lock(s)/doorbell(s) 202 may include a user input device (e.g., touchpad or keypad) to receive information (e.g., user input) from the user, and this information may be transmitted to and utilized by an event center (e.g., monitoring service 214) in responding to a reported emergency event. For example, any of the lock(s)/doorbell(s) 202 may be configured to require authentication or input from the user in various scenarios, which may include (i) inputting a password (e.g., numeric) to access the building and/or report an emergency event, (ii) performing a predetermined gesture (e.g., three second press-and-hold of a feature) to report an emergency, (iii) confirming the existence of an ongoing emergency event and/or the need for assistance from a public authority (e.g., pressing “Yes” in response to a prompt stating “Do you need 911 assistance?”), and/or (iv) providing additional information to a monitoring service or public authority (e.g., changes in symptoms for a reported health emergency, criminal description for a reported crime, etc.). By way of example, the lock(s)/doorbell(s) 202 may be distinct from the hub 206. Alternatively, the lock(s)/doorbell(s) 202 may perform the same or the similar functions as the hub 206.

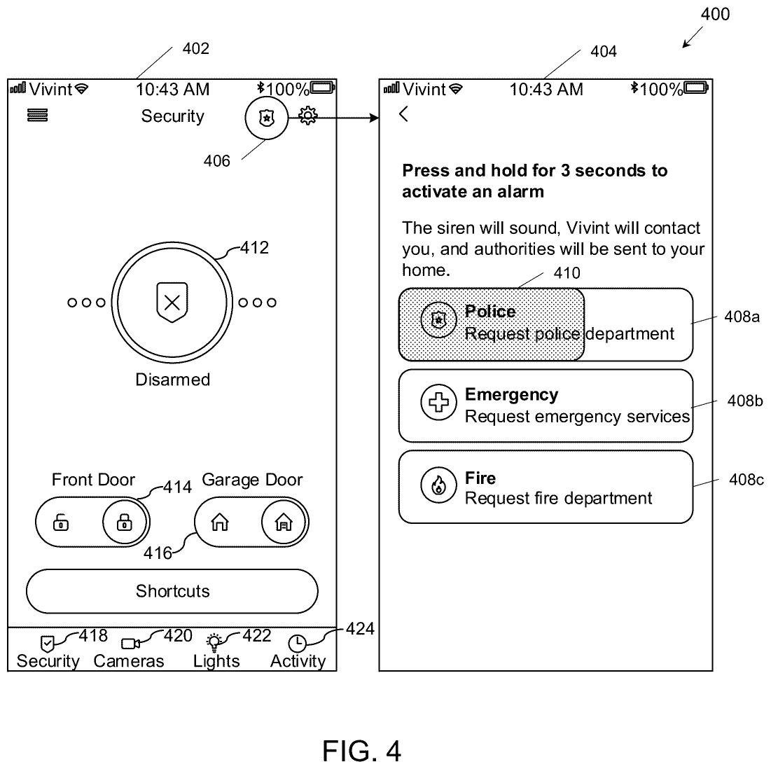

The user device 204 (e.g., a mobile electronic device, such as a smartphone) may be any type of electronic device comprising hardware components (e.g., one or more processors, non-transitory storage medium, electronic display configured to support an interactive user interface) and software components capable of performing the various processes and tasks described herein. By way of example, the user device 204 is distinct from the user interface of FIG. 1, however, the user device 204 may be the same user interface 119 of FIG. 1, in which case the description is incorporated herein. Non-limiting examples of the user device 204 include personal computers (e.g., laptop computers, desktop computers), server computers, mobile devices (e.g., smartphones, tablets), VR devices, and gaming consoles, smart watches, among other types of electronic devices. In an illustrative embodiment, the user device 204 is a mobile electronic device (e.g., smartphone) executing one or more mobile applications or app(s) that are configured to communicate with (e.g., transmit to and receive from) the various components of the network environment 200. The user device 204 may include an electronic display (e.g., LCD screen) for displaying a user interface (e.g., the user interfaces 402-404 of FIG. 4), communication electronics, and/or a physical housing.

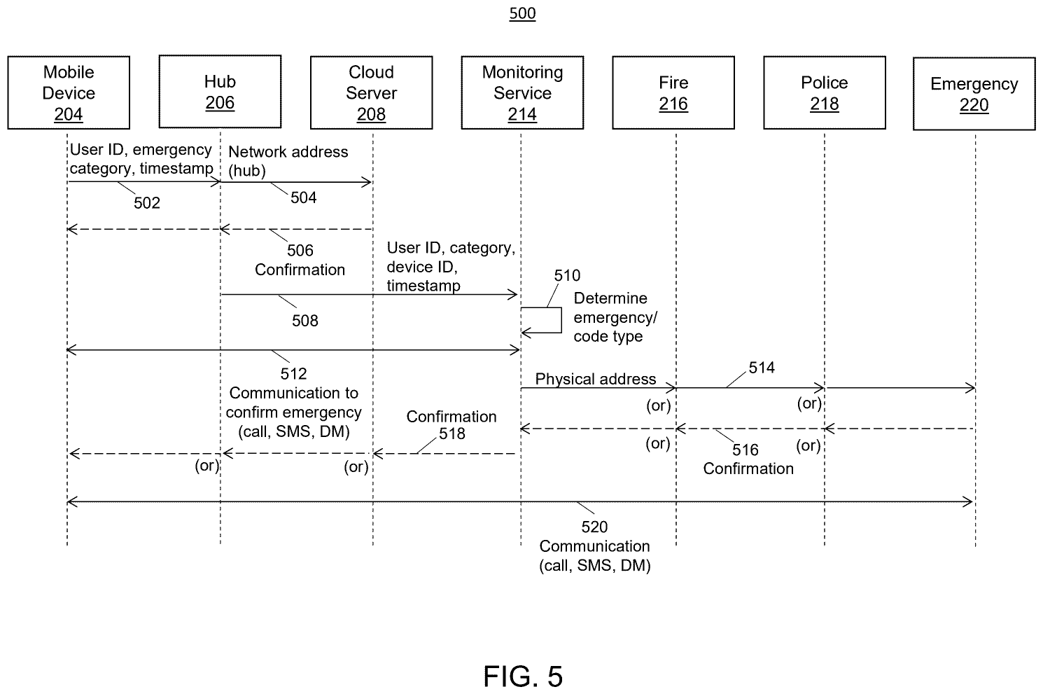

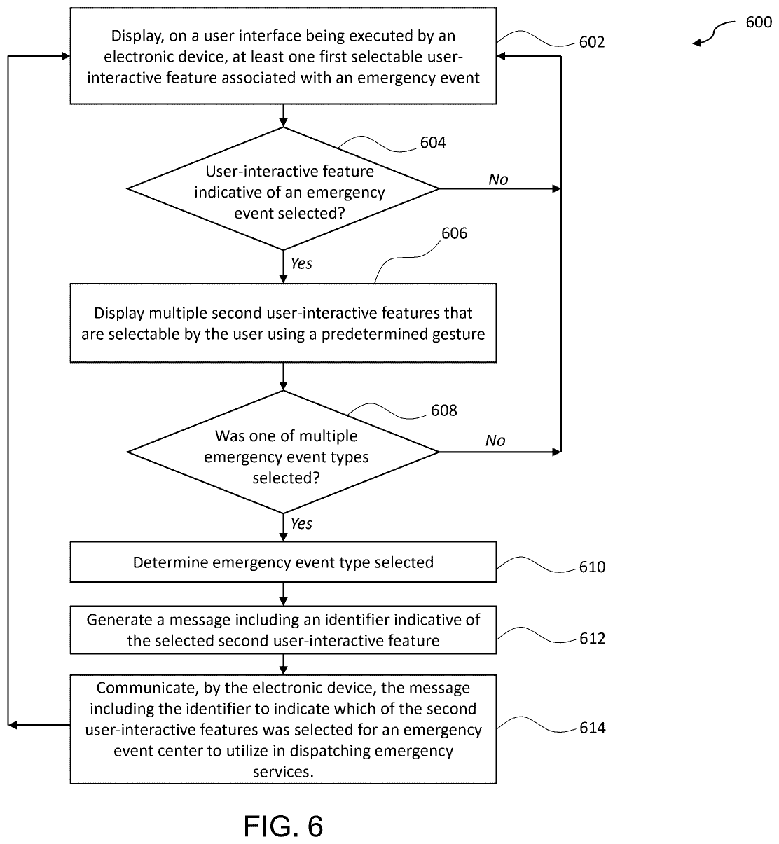

The user device 204 may include one or more computing devices configured to execute one or more software programs (e.g., mobile applications or apps) to perform various processes (e.g., the process 500 of FIG. 5 and/or the process 600 of FIG. 6). In some embodiments, the user device 204 may be a computer or computing device capable of performing the same or similar methods disclosed herein as performed by the user device 204. The user device 204 may include a processor and non-transitory, computer-readable medium including instructions, which, when executed by the processor, causes the processor to perform methods disclosed herein. Although FIG. 2 shows only a single user device 204, any number of devices associated with one or more users may be configured in the same or similar manner. In some cases, the computing devices of the user device 204 may perform all or portions of the processes of the lock(s)/doorbell(s) 202 and/or the hub 206.

By way of example, the user of the network environment 200 may interact with the user device 204 to select one or more selectable elements or “features” (e.g., second user-selectable feature 408a of FIG. 4). The user may select the feature indicating an emergency event category experienced by the user and/or provide additional information related to the emergency event, as further described in detail regarding FIG. 4. In response to receiving the indications of the selected feature(s), the user device 204 may transmit control signals (either directly or indirectly) corresponding to the selected feature(s) to one or more components of the network environment 200 (e.g., lock(s)/doorbell(s) 202, hub 206, cloud server 208, etc.). Other user interface elements/features and processes for interacting with these elements/features may be provided and utilized in reporting and responding to emergency events.

The hub 206 may be configured to perform functions similar to, or the same as, the controller 106 of FIG. 1, as previously described. For example, the hub 206 may include one or more processors that execute one or more software programs to perform various processes (e.g., the process 500 of FIG. 5 and/or the process 600 of FIG. 6) and a non-transitory, computer readable medium including instructions, which, when executed by the processor(s), cause the processor(s) to perform methods disclosed herein. The hub 206 may be communicatively coupled with the various components of the network environment 200 and/or other smart devices of the building directly or indirectly (e.g., through the network(s) 212, as shown in FIG. 2). By way of example, the hub 206 may receive control signals from, and transmit the control signals to, the lock(s)/doorbell(s) 202, the mobile device 204, the server 208, and other components of the network environment 200. The hub 206 may be further configured to receive various communication protocol signals and translate the various communication protocol signals into control signals to control the various components of the network environment 200.

The server 208 (e.g., cloud-based server) may include one or more processors that execute one or more software programs to perform various processes (e.g., the process 500 of FIG. 5 and/or the process 600 of FIG. 6) and a non-transitory, computer readable medium including instructions, which, when executed by the processor(s), cause the processor(s) to perform methods disclosed herein. Although FIG. 2 shows only a single server 208, the server 208 may include any number of computing devices. In some cases, the computing devices of the server 208 may perform all or portions of the processes described herein to support the network environment 200. The server 208 may include computing devices (e.g., processors) operating in a distributed or cloud computing configuration and/or in a virtual machine configuration. It should also be appreciated that, in some embodiments, one or more functions of the server 208 may be partly or entirely performed by the lock(s)/doorbell(s) 202 or any other component (e.g., mobile device 204, hub 206) of the network environment 200.

For ease of description and understanding, FIG. 2 depicts the network environment 200 as having one or a small number of each component. Embodiments may, however, include additional or alternative components, or omit certain components, from those of FIG. 2 and still fall within the scope of this disclosure. As an example, it may be common for embodiments to include multiple servers 208 and/or multiple databases 210 that are communicably coupled to or operated by the server 208 and the lock/doorbell 202 through the network 212. Embodiments may include or otherwise implement any number of devices capable of performing the various features and tasks described herein. For instance, FIG. 2 depicts the database 210 as hosted as or operated as a distinct computing device from the server 208, though, in some embodiments, the server 208 may include an integrated database 210 hosted by the server 208.

The network environment 200 may include or utilize one or more networks 212, which may include any number of internal networks (e.g., LANs), external networks (e.g., WANs), private networks (e.g., intranets, VPNs), and public networks (e.g., Internet). The network(s) 212 may include various hardware and software components for hosting and conducting communications amongst the components of the network environment 200. Moreover, non-limiting examples of such internal or external networks 212 may include a Local Area Network (LAN), Wireless Local Area Network (WLAN), Metropolitan Area Network (MAN), Wide Area Network (WAN), and the Internet. The communication over the networks 212 may be performed in accordance with various communication protocols, such as Transmission Control Protocol and Internet Protocol (TCP/IP), User Datagram Protocol (UDP), and IEEE communication protocols, among others. Additional, and/or alternative communication protocols that may be used by the network(s) 212 may include Wi-Fi, Bluetooth, Zigbee, Z-Wave, Thread, Insteon, LoRaWAN, KNK, DALI, and/or UPnP.

The network environment 200 may further include an event center or “monitoring service” 214. The monitoring service 214 may be a residential security monitoring service, commercial security monitoring service, emergency response service, law enforcement liaison service, home automation control center, third-party monitoring platform, government agency, emergency event center, central event dispatcher, or otherwise. For example, the monitoring service may be commercial emergency event center associated and integrated with the smart lock system. In another example, the monitoring service 214 may be an emergency telecommunications dispatcher or a central event dispatcher (e.g. 911 operator). The monitoring service 214 may receive and utilize information for a variety of uses including determining whether an emergency event exists, the type of emergency event (e.g., category, device identifier of device used for reporting), whether to contact public authorities (e.g., police), verifying that a person is a specific person (e.g., an authorized user, on a blacklist, etc.), and so on.

The network environment 200 may also include fire authority 216, police authority 218, and emergency authority 220 (collectively authorities 216-220). Each of the authorities 216-220 may be an entity related to or tasked with responding to an emergency event, such as a public authority, private entity (e.g., private security company), volunteer organization, specialized emergency service, and/or more. Further, each of the authorities 216-220 may correspond to a specific category of emergency. For example, fire authority 216 may be a local fire department tasked with addressing fire outbreaks and conducting rescue operations in such scenarios (e.g., building fires, smoke, etc.). Police authority 218 may be a local police department responsible for maintaining public order, ensuring safety, and responding to criminal incidents (e.g., home break-in, theft, etc.). Emergency authority 220 may be an Emergency Medical Services (EMS) agency or other entity related to or assigned to handle health events (e.g., heart attacks, strokes, etc.). One or more components of the network environment 200 (e.g., lock(s)/doorbell(s) 202, mobile device 204, hub 206, server 208) may transmit information to one or more of the authorities 216-220 in response to the user of the network environment 200 reporting an emergency event, as further described herein.

Control and informational signals may be transmitted between the components of the network environment 200. For example, the signals 222a-222i (collectively 222) may be transmitted between and amongst components through the network(s) 212. As described herein, the signals 222 may be transmitted utilizing any suitable communication protocol. According to illustrative embodiments, the signals 222 may be transmitted directly between components of the network environment 200. Additionally and/or alternatively, the signals 222 may be transmitted from a component of the network environment 200 (e.g., lock(s)/doorbell(s) 202) in response to a user performing an action (e.g., reporting an emergency event). Further, the signals 222 may be transmitted from a first component of the network environment 200 to a second component (e.g., the hub 206) and then relayed from the second component to one or more other components of the network environment 200 (e.g., server 208, authorities 216-220, etc.).

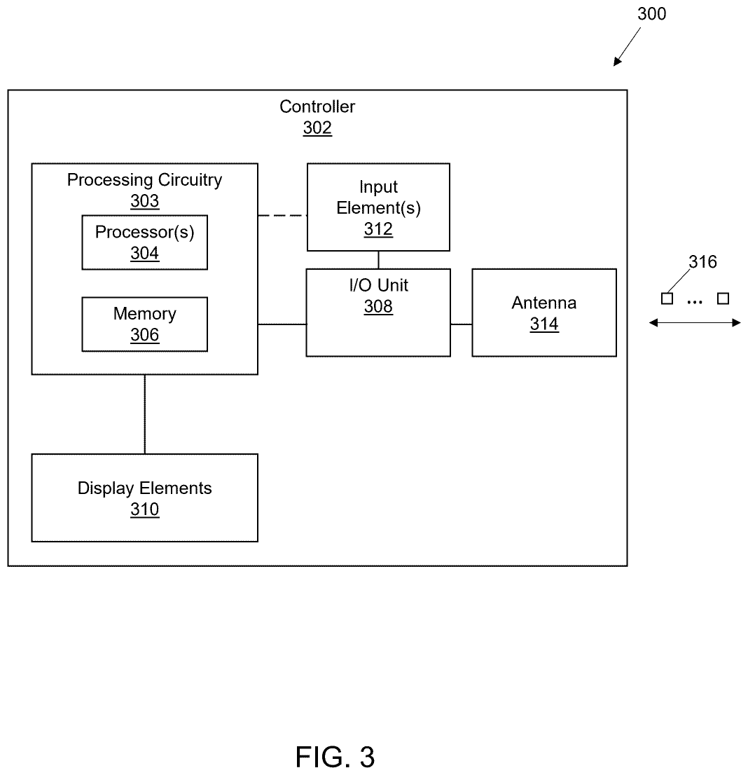

Turning now to FIG. 3, a block diagram of illustrative circuitry 300 of a controller 302 is shown. In some embodiments, the controller 302 may be configured for use in controlling and operating an alarm system that may also include one or more smart locks positioned on or about a space enclosed by one or more walls with at least one entrance, fire alarm sensor, radon sensor, carbon monoxide sensor, etc. In other embodiments, the controller 302 may be configured to receive and/or transmit signals associated with an emergency event, such as a fire alarm. The circuitry 300 may be formed of multiple electronic circuits and modules, including processing circuitry 303 including one or more processors 304 and a memory 306, an input/output unit 308, one or more display elements 310, input element(s) 312, antenna(s) 314 for communicating signals 316 (e.g., communication signals, control signals, data signals, etc.) over one or more frequency bands and using one or more different communication protocols, and so on. The processor(s) 304 may general processors, image processors, digital signal processors, application specific integrated circuits, and/or otherwise configured to execute software to manage operations of the processing circuitry 303 for communicating with and operating the smart lock(s). It should be understood that other components, such as camera(s) speaker(s), illumination devices(s), biometric sensors, motion sensor(s), range sensor(s), or otherwise may be integrated into the controller 302 and be supported by the processing circuitry 303, software being executed thereby, and/or other electronic components. The circuitry 300 may be integrated with any of the lock(s)/doorbell(s) 202, the mobile device 204, and/or the hub 206 of FIG. 2. The circuitry 300 may be used to execute/perform various methods and processes (e.g., the process 500 of FIG. 5 and/or the process 600 of FIG. 6), as further described herein.

With regard to FIG. 4, an illustration of a system 400 (e.g., mobile electronic device) including illustrative user interface(s) 402 and 404 used in app-based event detection is shown. In an embodiment, the user interface 402 may include a first user-interactive feature 406. The user interface 404 may further include second user-interactive features 408a-408c (collectively 408). The user interface 404 may also display a status (or progress) indicator 410 in response to the user selecting one or more of the second user-interactive features 408.

The user interface 402 may be configured to be executed on the system 400, such as a mobile device (e.g., smartphone) or otherwise (e.g., desktop computer, smart lock, smart lock interface, hub, etc.). In the embodiment shown on FIG. 4, the user interface 402 may display a “home screen” of a smart lock system. For example, the user interface 402 may be configured to display upon a user of the electronic device initially launching a mobile app associated with the system 400, or otherwise upon initial launch of the system 400 via another electronic device. The user interface 402 may be configured to display information associated with the alarm system, such as an alarm status feature 412, which may be selectably engaged to arm and disarm the alarm system. The alarm status feature 412 may further identity a state of the alarm system (e.g., armed/disarmed, activated/deactivated). Other control features 414 and 416 may enable the user to respectively control and/or view lock states of the front door and garage door. Control elements 418-424 may support links to other user interfaces or simply control devices (e.g., a “Security” page, “Cameras” page, etc.), and/or more. The user interface 402 may also be configured to display information associated with the system 400 executing the user interface 402, including the battery power, Internet connection, etc. of the system 400.

As previously described, the user interface 402 may include user-interactive element (or “features”) that may be configured to activate (or trigger) one or more actions associated with the system 400 in response to the user selecting one or more of the user-interactive features. As shown, icons may be associated with a user-interactive features, and each icon may be chosen to correspond to one or more actions that may be activated when the user-interactive feature is selected by the user. For example, the first user-interactive feature 406 may include an icon illustrating a “badge” and be configured to display a user interface associated with official emergency services (e.g., police, fire, etc.) in response to the user selecting (e.g., tapping, clicking, etc.) the “badge” icon (i.e., the first user-interactive feature 406). While the example above illustrates the first-user interactive feature 406 having an icon associated with the action activated by selecting the feature 406, it should be understood that additional and/or alternatives icons (or other identifiers) may be utilized, and these identifiers may be associated with or unrelated to the action that may be activated upon selection of the user-interactive feature including the identifier.

In operation, the first user-interactive feature 406 may be configured to cause the user interface 404 to be displayed in response to the user performing a predetermined gesture associated with the first user-interactive feature 406. The predetermined gesture used to select each of the user-interactive feature(s) may be any user action, inaction, series of actions, or combination thereof configured to be interpreted as a command by the system 400 or by the electronic device executing user interface(s) 402 and/or 404. For example, a user of the user interface 404 may select the first user-interactive feature 406 by tapping the feature and/or associated icon (e.g., via a touchscreen of an electronic device executing the user interface 404), by pressing and holding the feature 406 for a predetermined period of time (e.g., a sustained press of three seconds), pressing the feature 406 two or more times consecutively, pressing the feature 406 once then pressing another user-interactive element included in user interface 402, or by using any other combination of deliberate gestures, sustained contact/pressing, absence of action, etc. to trigger a command associated with the system 400, the user interface 402, and/or the first user-interactive feature 406. In an embodiment, a predetermined gesture for selecting the first user-interactive feature 406 may be a typical click or tap of a button to cause a selection. Because the selection of the first user-interactive feature 406 does not cause a communication to a monitoring service, a gesture, such as a three-second hold, multiple press, etc., that provides more security than a typical click or tap to avoid an inadvertent communication to the monitoring service may be used for the second-user interactive features, as further described herein.

Further, the system 400 and user interface(s) 402-404 may be configured to activate different actions in response to the user selecting one or more user-interactive features using the same predetermined gesture in different scenarios, or to trigger inaction instead of action depending on the general system operating conditions (e.g., date and time, internet connection) or on information relating to the smart lock system (e.g., lock status, alarm status). For example, a different action may be activated by the user selecting the first-user interactive feature 406 if the system is (i) in an armed (activated) state or (ii) in a disarmed (deactivated) state. If the feature 406 is selected (e.g., with a single press) while the alarm system is in an disarmed state, for example, an additional state (e.g., user interface, prompt, etc.) other than that of user interface 404 may be displayed. In this example, the display of user interface 404 may be delayed until the user takes an action or inaction associated with the additional state (e.g., pressing “confirm” on a pop-up window). Alternatively, if the same single-press action is performed on feature 406 while the alarm system is activated, then the user interface 404 may immediately be displayed without prompting the user for additional input.

In the embodiment shown on FIG. 4, the user interface 404 may display an “emergency interface” of an alarm. In this example, the user interface 404 may be configured to display information and/or features to assist a user in communicating an emergency (or emergency event) being experienced by the user (e.g., a break-in, fire, or health event) to a monitoring service and/or public authority. For example, the user interface 404 may include textual information (e.g., instructions) for a user to reference when experiencing an emergency event. As shown on FIG. 4, for example, the user interface 404 may include text to inform a user of the predetermined gesture to select the second user-interactive feature(s) 408 (e.g., “Press and hold for 3 seconds to activate an alarm”) and/or steps that may be taken in response to the user performing the predetermined gesture (e.g., “The siren will sound, Vivint will contact you, and authorities will be sent to your home”).

Further, each of the second user-interactive features 408 may be associated with an emergency category and a monitoring service/public authority responsible for assisting during related emergency events. For example, the second user-interactive feature 408a may include text and/or images associated with the a crime related event and/or law enforcement officials, including the word “Police” in bold lettering, the text “Request police department,” and/or an icon that may be associated with police (illustrated in FIG. 4 as a badge). The second user-interactive feature 408b may be associated with an health emergency event (e.g., a heart attack, stroke, etc.) and be aligned with related text and/or images including the word “Emergency” in bold lettering, the text “Request emergency services,” and an icon that may be associated with one or more of a health emergency, a hospital, paramedics, or other health-related concept (illustrated in FIG. 4 as an non-color outline of a “red cross” typically associated with healthcare services). Further, the second user-interactive feature 408c may include text and/or images associated with a fire-related emergency event, including the word “Fire” in bold lettering, the text “Request fire department,” and/or an icon that may be associated with a fire-related event (illustrated in FIG. 4 as a “flame” or small fire). It should be understood that additional and/or alternative user-interactive features may be provided to enable the user to specify additional and/or different emergencies, possibly with more details.

As described with regard to the first user-interactive feature 406, the second user-interactive feature(s) 408 may be selected by the user performing a predetermined gesture associated with one or more of the second user-interactive feature(s) 408. As described above, the predetermined gesture may be any user action, inaction, series of actions, or combination thereof configured to be interpreted as a command by the system 400 or by electronic device executing the user interface(s) 402-404. For example, a user of the user interface 404 may select the second user-interactive feature 408a by pressing and holding the feature 408a for a predetermined period of time (e.g., three seconds). As shown, pressing and holding the feature 408a may activate an action associated with the feature 408a, such as alerting a monitoring serving and/or public authority to the status of an ongoing emergency, as further described herein. In some embodiments, performing the predetermined gesture may cause the electronic device displaying user interface 404 to enter an “alarm state” such that the user cannot interact with other features included on the user interface.

In response to the user performing a predetermined gesture as described above, the user interface 404 may be configured to display a status indicator 410 associated with one or more user-interactive features selectable by the user and included on the user interface 404. As shown in FIG. 4, for example, the status indicator 410 may be associated with the second user-interactive feature 408a, and the status indicator 410 may be configured to display information relating to the system 400, user interface 404, and/or second user-interactive feature 408a in response to the user selecting the feature 408a using the predetermined gesture (e.g., press and hold). In an embodiment, the status indicator 410 may be configured to display upon a user performing an initial step of a predetermined gesture (e.g., the initial “press” of a three-second press-and-hold sequence). Further, the visual appearance of status indicator 410 may be dynamically adjusted in response to various scenarios and depending on the user's status (or progress) in performing a predetermined gesture (e.g., a multi-part gesture).

For example, as illustrated regarding second user-interactive features 408b-408c, the status indicator 410 may be configured to operate in an “OFF” state until a user performs an initial action associated with one or more predetermined gestures (e.g., the initial “press” of a press-and-hold gesture). In response to the user first pressing the feature 408a, the status indicator 410 may be configured to display in an state indicative of the progress the user has made in performing the predetermined gesture (e.g., as a visual representation of a “progress bar” or “loading bar” overlaying the second user interactive feature 408a, as shown). For example, if the user has performed the initial “press” of a multi-part press-and-hold gesture, the status indicator 410 may be configured to appear in an initial state indicating an initial portion of the predetermined gesture may have been performed. In another embodiment, the status indicator 410 may be configured to remain in an “OFF” state (e.g., delay appearing on the user interface 404) until the user has continued to perform the predetermined gesture (e.g., for a predetermined time associated with the initial state, such as 0.1 second).

Further, as the user continues to perform the predetermined gesture after performing the initial action of the predetermined gesture (e.g., continues to hold for longer than 0.1 seconds after initially pressing), the visual appearance of status indicator 410 may be configured to dynamically adjust in response to the progress the user has made in performing the predetermined gesture, and the appearance of status indicator 410 at a given point in time may correspond to the overall progress made by the user in performing the predetermined gesture. For example, the status indicator 410 may be configured to display as a “loading bar” overlaying the second-user interactive feature following the display of the initial state as the user continues to press and hold the second user-interactive feature 408. As shown on FIG. 4, for example, the status indicator 410 may appear as a contrasting visual feature occupying and/or overlaying second user-interactive feature 408a. It should be understood that the duration of time (e.g., 3 seconds) or other gesture may be used to avoid inadvertent false alarms.

The status indicator 410 may be configured to appear in various states, colors, shapes, combinations, etc., such as (i) a progress bar that gradually fills in to indicate the degree of completion of the predetermined gesture (e.g., linearly or non-linearly), (ii) an icon that changes in color (e.g., transitioning from white to red gradually over the period of time required to complete the predetermined gesture), (iii) a numeric display providing a direct numerical representation of the time or steps remaining to complete the gesture, or (vi) otherwise. In another embodiment, the status indicator 410 may be configured to display in a state directly/proportionally related to the progress the user has made in performing the predetermined gesture. For example, if the user has performed two seconds of a press-and-hold gesture requiring the user to press-and-hold for three seconds, the status indicator 410 may be configured to appear as a loading bar that is two-third's full. The status indicator 410 may be further configured to dynamically adjust its appearance (e.g., transition to an “OFF” state) in response to the user completing the gesture.

In other examples, there may exist a non-linear relationship user's progress in performing a predetermined gesture, such as the status indicator 410 remaining in an “OFF” state until a user has completed one or more steps of the predetermined gesture, then transitioning to an “ON” state indicative of further progress made by the user in performing additional steps of the predetermined gesture. For example, assume a three second press-and-hold sequence is assigned as the predetermined gesture associated with second user-interactive feature 408a. In this example, the status indicator 410 may be configured to remain “OFF” while the user is in progress performing the first second of the three-second press and hold (e.g., has pressed and held feature 408a for 0-0.99 seconds). The status indicator 410 may be configured to transition to an “ON” state following completion of the first second of the predetermined gesture (e.g., displaying as an unfilled loading bar overlaying feature 408a in response to the user pressing and holding for one second) and/or to display in a dynamic state indicative of the progress the user has made in performing the remaining portion of the predetermined gestured (e.g., as a half-filled loading bar when the user has performed two seconds of the press-and-hold, a filled loading bar when the user has performed three seconds of the press-and-hold, etc.). In an example, the status indicator 410 may be further configured to transition to an “OFF” state in response to the user completing the gesture (e.g., the loading bar may disappear once the user has completed all three seconds of the press-and-hold gesture). In another example, the status indicator 410 may be configured to appear in an “ON” state if the user begins to perform the predetermined gesture and transition to an “OFF” state if the users stops performing the predetermined gesture. While the examples above are included for purposes of illustration, it should be understood that the status indicator 410 may be configured to display in additional and/or alternative states, colors, shapes, etc. that may or may not correspond to the progress made by a user in performing a predetermined gesture.

With regard to FIG. 5, a “swim-lane” flowchart of an illustrative process 500 for app-based event detection is shown, according to an embodiment. The process 500 may begin in step 502, where the mobile device 204 may transmit information to the hub 206. For example, the process 500 may begin at step 502 in response to the user performing a predetermined gesture associated with an emergency event (e.g., as illustrated regarding the first user-interactive feature406 and second user-interactive features 408 of FIG. 4). The information transmitted by the mobile device to the hub 206 in step 502 may include a user identifier (e.g., username, user ID, etc.), code type or emergency category (e.g., “Fire,” “Police,” “Emergency,” etc.), device identifier (e.g., emergency reported from mobile device 204, from the hub 206, from the interior lock interface, etc.), and/or any other information related to an emergency event (e.g., date, timestamp, etc.). In step 504, the hub 206 may transmit information to the cloud server 208, which may include information transmitted to the hub 206 from the mobile device in step 502 and/or additional information (e.g., network address of the hub 206). In an embodiment, it may be possible to communicate physical address (e.g., house address, apartment address, room number, room name, building number, etc.), but the network address may enable the could server 208 to perform a look-up of the physical address using the network address.

In response to receiving the transmitted information in steps 502 and/or 504, the hub 206 and/or cloud server 208 may optionally return a confirmation to the mobile device 204 and/or hub 206 in step 506. The confirmation optionally returned to the mobile device 204 and/or hub 206 in step 506 may include information as described regarding the information transmitted by the mobile device in steps 502-504 (e.g., user ID, code type (emergency category, device ID), etc.), as well as addition information (e.g., confirmation indicator). In step 508, the hub 206 may transmit information to the monitoring service 214, which may include any information acquired during steps 502-506 (e.g., user ID, code type, timestamp, network address, etc.) and/or any additional information that may be utilized by the monitoring service (e.g., physical address, type of residence, etc.). The monitoring service 214 may then determine the emergency type corresponding to the information transmitted in step 510.

In one embodiment, the monitoring service may determine the emergency type by receiving and analyzing at least one code indicative of (i) the emergency category (e.g., fire) and (ii) a device identifier of the device used to transmit a signal corresponding to the emergency (e.g., mobile device, smart lock interface). For example, a code sequence sent to the monitoring service in step 508 may include a segment/portion identifying “fire” and another segment identifying “primary interior lock interface” to communicate both the emergency type (e.g., fire) and device identifier (e.g., triggered from a mobile device of a user) to the monitoring service to enable an appropriate response.

In step 512, the monitoring service may communicate with the mobile device (e.g., to confirm the emergency). For example, the monitoring service may place a call, send an SMS message, send a direct message (DM), etc. to the mobile device and attempt to communicate with a user having access to the mobile device. In one embodiment, the monitoring service may call a phone number associated with the mobile device and attempt to confirm the existence of an emergency event (e.g., an ongoing emergency such as a stroke, home fire, break-in, etc.) in step 512. If the emergency was reported via a smart lock interface, the monitoring service may send a notification to the smart lock interface prompting the user to confirm the existence of the reported emergency. If the monitoring service does not confirm the existence of an emergency in step 512 (e.g., a user does not answer a call/respond to a message, responds that she does not need assistance, etc.), the process 500 may (i) exit and/or (ii) continue and perform one or more of steps 514-520 (e.g., contacting an emergency authority, etc.). If the monitoring service confirms the existence of an ongoing emergency event (e.g., user answers the phone and confirms needing assistance), the process 500 may continue and perform one or more of steps 514-520, as further described herein.

Depending on the emergency type determined in step 510 and whether the emergency was confirmed in step 512, the process 500 may continue with the monitoring service 214 transmitting information to one of more of (i) the fire authority 216 or other public authority designated to assist with fire-related emergency events, (ii) the police authority 218 or other public authority designated to assist with crime-related emergency events, and/or (iii) the emergency authority 220 or other public authority designated to assist with health-related emergency events. The information transmitted in step 514 may include information as described regarding the information transmitted in steps 508 (e.g., user ID, emergency category, activation source, etc.) as well as additional/alternative information (e.g., physical address). In step 516, one or more of the fire authority 216, police authority 218, and emergency authority 220 may optionally transmit a confirmation signal to the monitoring service 214. Further, in step 518, the monitoring service may optionally transmit a confirmation to one or more of the cloud server 208, hub 206, and/or mobile device 204 in response to receiving the confirmation in step 516.

In step 520, one or more of the fire authority 216, police authority 218, and/or emergency authority 220 may transmit a communication to the cloud server 208, hub 206, and/or mobile device 204. For example, in response to receiving a communication from the monitoring center in step 514, the fire authority 216 may initiate a phone call to a mobile device of an authorized user in step 520. In another example, the police authority 218 may transmit an SMS message to the cloud server 208 in step 520. The communication transmitted by one or more authorities 216-220 in step 520 may include information such as the status of the emergency authority's response to the reported emergency (e.g., “Police have been dispatched to your home address”), information or queries for a user experiencing the emergency (e.g., “What room in your home are you located?,” “Do you require assistance?”), and/or otherwise.

With regard to FIG. 6, a flowchart of an illustrative process 600 for app-based event detection is shown, according to an embodiment. The process 600 may begin in step 602 by displaying, on a user interface being executed by an electronic device (or data processing system), at least one first selectable user-interactive feature associated with an emergency event. In step 604, the process 600 may further include determining whether a user-interactive feature indicative of an emergency event was selected. If a user-interactive feature indicative of an emergency event is not selected, the process 600 may return to the initial step 602. Alternatively, if a user-interactive feature indicative of an emergency event is selected, the process 600 may continue to step 606, and multiple second user-interactive features may be displayed that are selectable by the user using a predetermined gesture. In step 608, the process 600 may further include determining whether one of multiple emergency event types were selected. If an emergency event type was not selected, the process 600 may return to the initial step 602. If one or more emergency event types were selected, the process 600 may continue in step 610 by determining the emergency event type selected. At step 612, the process 600 may further include generating a message including an identifier indicative of the selected second user-interactive feature. The process 600 may continue to step 614 and communicate, by the electronic device, the message including the identifier to indicate which of the second user-interactive features was selected for an emergency event center to utilize in dispatching emergency services, and the process 600 may then return to the initial step 602.

In step 602, the user interface displayed (e.g., by the data processing system) may be the user interface 402 of FIG. 4 (e.g., a “home screen”). As described with regard to FIG. 2, the user interface displayed in step 602 may be displayed via an electronic device, such as a hub 206 or a mobile device 204 of a user. The user may interact with the electronic device displaying the user interface in step 602 by selecting a first user-interactive feature indicating an emergency event (e.g., first user-interactive feature 406) via the device (e.g., using a predetermined gesture). In response determining that the user selects the first-user interactive feature indicating the emergency event in step 604, the electronic device may display a second user interface (e.g., an “emergency interface,” user interface 404 of FIG. 4) in step 606 for selecting one of multiple emergency events. For example, the second user interface may include multiple second user-selectable features corresponding to specific emergency event categories (e.g., feature 408a of FIG. 4 corresponding to “Fire”).

In an embodiment, if multiple emergency event categories are selected by the user in step 608 (e.g., “fire” and “police”), step 610 may include determining which of the multiple selected event categories to assign to the reported emergency event. Further, the message indicative of the selected emergency type generated in step 614 and communicated in step 616 may include information such as (i) an identifier of the emergency category (e.g. “Fire”), (ii) a “device identifier” or indicator of the electronic device used to trigger the emergency event (e.g., “mobile device”), and/or more.

One method for reporting an event may include displaying, on a user interface being executed by an electronic device, one or more user-interactive feature(s) that are selectable by a user. In response to the user selecting one of the first user-interactive features, the method may further include displaying a plurality of second user-interactive features that are selectable by the user using a predetermined gesture. Further, in response to the user selecting one of the second user-interactive features by performing the predetermined gesture, the method may include generating a message including an identifier indicative of the selected second user-interactive feature and communicating the message including the identifier indicative of the selected second user-interactive feature to an event center.

In an embodiment, communicating may include communicating the message to a hub located in a residential location.

Communicating may include communicating the message to a hub via a cloud-based server which, in response, may be configured to identify a network address associated with the hub based on the message and communicate a second message to the hub inclusive of the message.

The method may further include determining, by the hub, a code type associated with the identifier included in the message and communicating, by the hub, a second message including a code type to a network address.

The method may further include generating, by the hub, the second message including the code type and physical address associated with the hub.

The method may further include generating, by the hub, the second message further including a device identifier indicative of the hub or the electronic device from which the user selected the first and second user-interactive features.

Generating a second message may include generating a mobile identifier associated with the electronic device, the electronic device being a mobile electronic device.

In an embodiment, communicating the second message to a network address may include communicating the second message to a network address of a central event dispatcher.

Displaying a plurality of second user-interactive features may include displaying a second user-interface inclusive of the second user-interactive features.

Generating a message may include identifying that the user selected the second user-interactive feature by holding the selected second user-interactive feature for a predetermined minimum amount of time longer than 1 second.

Another embodiment relates to a system including a non-transitory memory, an electronic display, and an input/output (I/O) unit. The system may include one or more processor(s) in communication with the memory, electronic display, and I/O unit and may be configured to display, on the electronic display, a user interface including at least one first user-interactive feature that is selectable by a user. In response to the user selecting one of the first user-interactive features, the processors may be further configured to display, on the electronic display, a plurality of second user-interactive features that are selectable by the user using a predetermined gesture. In response to the user selecting one of the second user-interactive features by performing the predetermined gesture, the processors may be further configured to generate a message including an identifier indicative of the selected second user-interactive feature. Further, the processors may be configured to communicate the message including the identifier indicative of the selected second user-interactive feature to an event center.

In an embodiment, the processors configured to communicate may be further configured to communicate the message to a hub located in a residential location.

The processors configured to communicate may be further configured to communicate the message to a hub via a cloud-based server and, in response, to identify a network address associated with the hub based on the message and communicate a second message to the hub inclusive of the message.

The hub configured to receive the message may be further configured to determine a code type associated with the identifier included in the message and to communicate a second message including the code type to a network address.

In another embodiment, hub may be further configured to generatethe second message including the code type and physical address associated with the hub.

The hub may be further configured to generate the second message further including a device identifier indicative of the hub or the electronic device from which the user selected the first and second user-interactive features.

The hub configured to generate the second message may be further configured to generate a mobile identifier associated with the electronic device, the electronic device being a mobile electronic device.

The hub configured to communicate the second message may be further configured to communicate the second message to a network address of a central event dispatcher.

In another embodiment, the electronic display configured to display the plurality of second user-interactive features may be further configured to display a second user-interface inclusive of the second user-interactive features.

The processors configured to generate the message may be further configured to identify that the user selected the second user-interactive feature by holding the selected second user-interactive feature for a predetermined minimum amount of time longer than 1 second.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments. These features and advantages of the embodiments will become more fully apparent from the following description and appended claims or may be learned by the practice of embodiments as set forth hereinafter.

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules to emphasize their implementation independence more particularly. For example, a module may be implemented as a hardware circuit comprising custom very large scale integrated (“VLSI”) circuits or gate arrays, off-the-shelf semiconductor circuits such as logic chips, transistors, or other discrete components. A module may also be implemented in programmable hardware devices such as an FPGA, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable for and/organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a server, cloud storage (which may include one or more services in the same or separate locations), a hard disk, a solid state drive (“SSD”), an SD card, a random access memory (“RAM”), a read-only memory (“ROM”), an erasable programmable read-only memory (“EPROM” or Flash memory), a static random access memory (“SRAM”), a Blu-ray disk, a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, a personal area network, a wireless mesh network, and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages.

The computer readable program instructions may execute entirely on the user's computer, partly on the user's computer, as a stand-alone software package, partly on the user's computer and partly on a remote computer or service or entirely on the remote computer or server or set of servers. In the latter scenario, the remote computer may be connected to the user's computer through any type of network, including the network types previously listed. Alternatively, the connection may be made to an external computer (for example, through the Internet using an Internet Service Provider). In some embodiments, electronic circuitry including, for example, programmable logic circuitry, FPGA, or programmable logic arrays (“PLA”) may execute the computer readable program instructions by utilizing state information of the computer readable program instructions to personalize the electronic circuitry to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical functions.

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Means for performing the steps described herein, in various embodiments, may include one or more of a sliding door lock, a sliding door, a window, a network interface, a processor (e.g., a CPU, a processor core, an FPGA or other programmable logic, an ASIC, a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for performing the steps described herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the principles of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided.

Accordingly, these terms should be interpreted as indicating that insubstantial or inconsequential modifications or alterations of the subject matter described and claimed are considered to be within the scope of the invention as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While the instant disclosure has been described above according to its preferred embodiments, it can be modified within the spirit and scope of this disclosure. This application is therefore intended to cover any variations, uses, or adaptations of the instant disclosure using the general principles disclosed herein. Further, the instant application is intended to cover such departures from the present disclosure as come within the known or customary practice in the art to which this disclosure pertains.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It is noted that any element disclosed in one embodiment may be incorporated or utilized with any other embodiment disclosed herein.

What is claimed is:

1. A method for reporting an event, comprising:
displaying, on a user interface being executed by an electronic device, at least one first user-interactive feature that is selectable by a user;
in response to the user selecting one of the first user-interactive features, displaying a plurality of second user-interactive features that are selectable by the user using a predetermined gesture;
in response to the user selecting one of the second user-interactive features by performing the predetermined gesture, generating a message including an identifier indicative of the selected second user-interactive feature; and
communicating, by the electronic device, the message including the identifier indicative of the selected second user-interactive feature to an event center.

2. The method according to claim 1, wherein communicating includes communicating the message to a hub located in a residential location.

3. The method according to claim 2, wherein communicating the message to a hub includes communicating the message via a cloud-based server, which, in response, is configured to:
identify a network address associated with the hub based on the message; and
communicate a second message to the hub inclusive of the message.

4. The method according to claim 2, further comprising:
determining, by the hub, a code type associated with the identifier included in the message; and
communicating, by the hub, a second message including the code type to a network address.

5. The method according to claim 4, further comprising generating, by the hub, the second message including the code type and physical address associated with the hub.

6. The method according to claim 5, further comprising generating, by the hub, the second message further including a device identifier indicative of the hub or the electronic device from which the user selected the first and second user-interactive features.

7. The method according to claim 5, wherein generating the second message includes generating a mobile identifier associated with the electronic device, the electronic device being a mobile electronic device.

8. The method according to claim 5, wherein communicating the second message to a network address includes communicating the second message to a network address of a central event dispatcher.

9. The method according to claim 1, wherein displaying a plurality of second user-interactive features includes displaying a second user-interface inclusive of the second user-interactive features.

10. The method according to claim 1, wherein generating a message includes identifying that the user selected the second user-interactive feature by holding the selected second user-interactive feature for a predetermined minimum amount of time longer than 1 second.

11. A system, comprising:
a non-transitory memory;
an electronic display;
an input/output (I/O) unit; and
one or more processors in communication with the memory, electronic display, and I/O unit, the one or more processors being configured to:
display, on the electronic display, a user interface including at least one first user-interactive feature that is selectable by a user;
in response to the user selecting one of the first user-interactive features, display, on the electronic display, a plurality of second user-interactive features that are selectable by the user using a predetermined gesture;
in response to the user selecting one of the second user-interactive features by performing the predetermined gesture, generate a message including an identifier indicative of the selected second user-interactive feature; and
communicate the message including the identifier indicative of the selected second user-interactive feature to an event center.

12. The system of claim 11, wherein the one or more processors, in being configured to communicate the message, are further configured to:
communicate the message to a hub located in a residential location.

13. The system of claim 12, wherein the one or more processors, in being configured to communicate the message to a hub, are further configured to:
communicate the message to the hub via a cloud-based server;
wherein the hub, in response to receiving the message, is configured to identify a network address associated with the hub based on the message; and
communicate a second message to the hub inclusive of the message.

14. The system of claim 12, wherein the hub, in response to receiving the message, is further configured to:
determine a code type associated with the identifier included in the message; and
communicate a second message including the code type to a network address.

15. The system of claim 14, wherein the hub is further configured to:
generate the second message including the code type and physical address associated with the hub.

16. The system of claim 15, wherein the hub, in generating the second message, is further configured to generate the second message further including a device identifier indicative of the hub or the electronic display from which the user selected the first and second user-interactive features.

17. The system of claim 15, wherein the hub, in generating the second message, is further configured is further configured to generate a mobile identifier associated with an electronic device corresponding with the electronic display, the electronic device being a mobile electronic device.

18. The system of claim 15, wherein the hub, in communicating the second message, is further configured to communicate the second message to a network address of a central event dispatcher.

19. The system of claim 11, wherein the electronic display, in displaying the plurality of second user-interactive features, is further configured to display a second user-interface inclusive of the second user-interactive features.

20. The system of claim 11, wherein the one or more processors are further configured to identify that the user selected at least one of the second user-interactive features by holding the selected at least one second user-interactive feature for a predetermined minimum amount of time longer than 1 second.
